(19) United States
(12) Patent Application Publication
(10) Pub. No.: US 2009/0231461 A1
(43) Pub. Date: Sep. 17, 2009

(54) IMAGE CAPTURE DEVICE PROVIDING COLOR ADJUSTMENT AND COLOR ADJUSTMENT METHOD THEREOF

(75) Inventors: WEI-JEN WANG, Tu-Cheng (TW); SHIH-PAO CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/166,335

(22) Filed: Jul. 2, 2008

(30) Foreign Application Priority Data
Mar. 17, 2008 (CN) 200810300604.2

(51) Int. Cl. H04N 9/73

(52) U.S. Cl. 348/223.1; 348/E05.024

(57) ABSTRACT

A digital still camera (DSC) includes an encoder, a display panel, and a color adjustment unit. The encoder is configured to encode an image signal in the DSC into a first preview image. The display panel is configured to display the first preview image to allow determination of the need for color adjustment. The color adjustment unit is configured to adjust the color of the image signal in response to a user input made based upon the determination. The adjusted image signal is also encoded by the encoder as a second preview image displayed by the display panel in real time to allow determination of the need for further adjustment, or to store the adjusted image signal.

### BACKGROUND

1. Field of the Invention

The present invention relates to image capture and, particularly, to an image capture device providing color adjustment and a color adjustment method thereof.

2. Description of Related Art

Color adjustment involves changing a color in an image or a portion of an image. This adjustment is conventionally accomplished in post-processing with a computer, which can be difficult and inconvenient.

Therefore, it is desirable to provide an image capture device and a color adjustment method, which can overcome the described limitations.

### SUMMARY

In an embodiment, a digital still camera (DSC) includes an encoder, a display panel, and a color adjustment unit. The encoder is configured to encode an image signal in the DSC into a first preview image. The display panel is configured to display the first preview image so that a user may judge if color adjustment is desired. The color adjustment unit is configured to adjust the color of the image signal in response to user input after the first preview image is displayed. The adjusted image signal is then encoded by the encoder as a second preview image displayed in real time by the display panel so that the user may judge if further color adjustment is needed or if the adjusted image may be accepted as a final image and stored.

### BRIEF DESCRIPTION OF THE DRAWINGS

Many aspects of the present image capture device and color adjustment method will be better understood with reference to the following drawings. The components in the drawings are not necessarily drawn to scale, the emphasis instead being placed upon clearly illustrating the principles of the present image capture device and color adjustment method. Moreover, in the drawings, like reference numerals designate corresponding parts throughout the several views.

FIG. 1 is a functional diagram of a digital still camera (DSC) including a display panel, according to a first exemplary embodiment.

FIG. 2 is a schematic view of the display panel of FIG. 1.

FIG. 3 is a flowchart of a color adjustment method, according to a second exemplary embodiment.

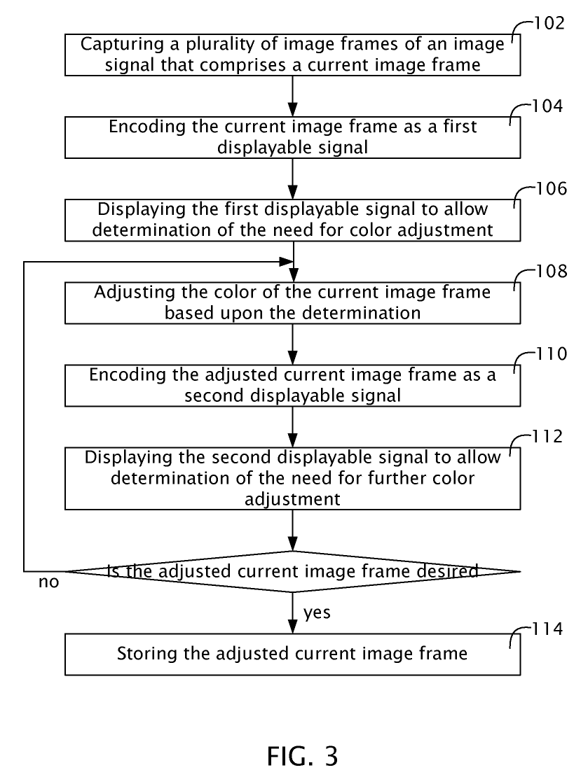

FIG. 4 is a flowchart of a color adjustment method, according to a third exemplary embodiment.

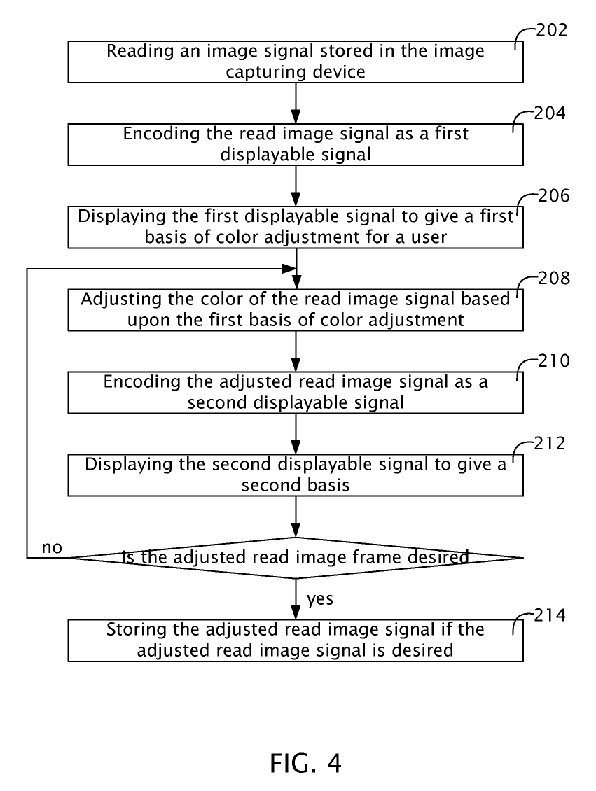

### DETAILED DESCRIPTION

Embodiments of the present image capture device and color adjustment method will now be described in detail with reference to the drawings. while, in the following described embodiments, the image capture device is a digital still camera (DSC), it should be understood that the image capture device is not limited by these embodiments and can be any other electronic device providing image capture capability such as a mobile phone with a camera module.

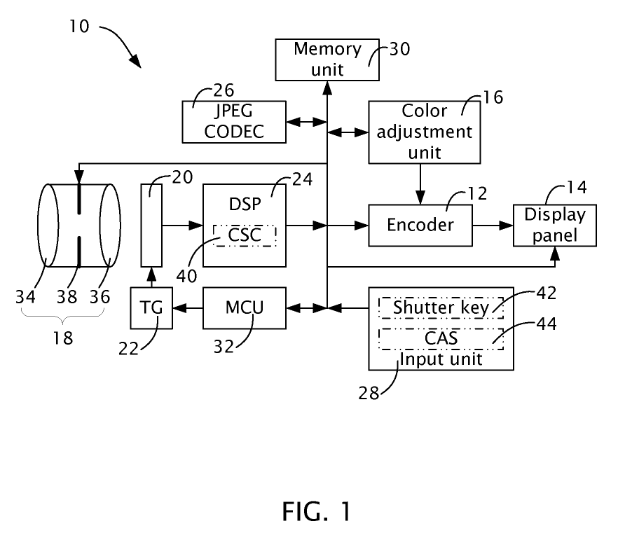

Referring to FIG. 1, a DSC 10, according to an exemplary embodiment, includes an encoder 12, a display panel 14, and a color adjustment unit 16. The encoder 12, such as a video encoder, is configured to encode an image signal currently generated by or stored in the DSC 10 (see following) into a first preview image, which may comprise a video signal (i.e., putting several images together as a video signal, or repeating a same image as a video signal). The display panel 14, such as a liquid crystal display (LCD) panel, is configured to display the first preview image. The color adjustment unit 16 is configured to adjust the color of the image signal in response to user input after the first preview image is displayed. The adjusted image signal is also encoded by the encoder 12 as a second preview image and can undergo further color adjustment or be accepted and stored.

In particular, the color adjustment unit 16 may adjust the color of the image signal by changing color values of pixels of the image signal in a specific color space (e.g., RGB, or YUV space, wherein Y represents luminance component, U, V represent two chrominance components, see following).

Typically, the DSC 10 further includes a lens unit 18, an image sensor 20, a timing generator (TG) 22, a digital signal processor (DSP) 24, a JPEG CODEC 26, an input unit 28, a memory unit 30, and a micro central unit (MCU) 32.

The lens unit 18 is configured to transmit an optical image to the image sensor 20, such as a charge coupled device (CCD). The image sensor 20 is configured to convert the optical image into an image signal. The TG 22 is configured to drive the image sensor 20 to repeat output of the image signal at a predetermined rate (e.g., 1/30s) as consecutive image frames.

Understandably, the lens unit 18 may include a zoom lens 34, focus lens 36, and a mechanical shutter 38 to enable the lens unit 18 to zoom and/or focus the optical image on the image sensor 20 and regulate exposure time of the image sensor 20. It should be noted that if the image sensor 20 is a CCD image sensor, an analog-to-digital converter (ADC, not shown) should be included in the image sensor 20 so that the image frames can be processed by the DSP 24. It also should be understood that the image sensor 20 bears a color filter of Bayer pattern such that the image frames may include three color components such as red (R), green (G), and blue (B) (RAW file). That is, the image frames may be represented in an RGB space.

The DSP 24 is configured for processing the image frames and may include an optical black clamping unit, a lens distortion compensation unit, a white balance unit, a gamma correction unit, a color interpolation unit (not shown), and a color space converter (CSC) 40 for applying various corresponding processing to the image frames. The CSC 40 is configured to convert the color space of the image signal RGB into YUV. That is, after color space conversion, the image frames may be also represented by color components YUV.

The JPEG CODEC 26 is configured to convert a current image frame of an image signal to a JPEG file. The memory unit 30 is configured to store the compressed JPEG file. The input unit 28 is configured to receive various user input instructing the MCU 32 to control and coordinate the various involved components of the DSC 10. For example, the input unit 28 may include a shutter 42 and color adjustment control (CAC) 44. The shutter key 42 is configured to activate the JPEG CODEC 26 to compress a current image frame or a current adjusted image frame when fully depressed as a JPEG file. The CAC 44 is configured to receive color adjustment parameters such as the color (component) needed to be changed or the amount of change, and thereby instructs the MCU 32 to control the color adjustment unit 16 based on the received color adjustment parameters.

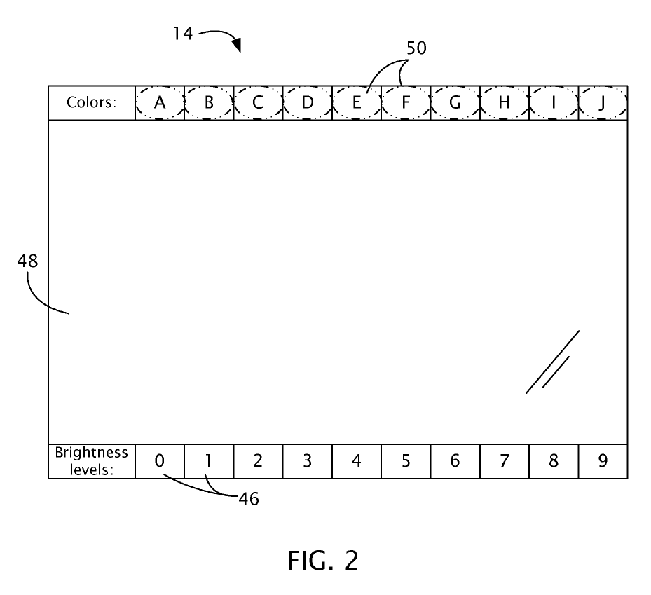

In this embodiment, the CAC 44 is incorporated into the display panel 14, as a touch screen. As shown in FIG. 2, a number of representations such as colors A˜J and brightness levels 0˜9 are shown in corresponding sensor locations 46 defined in the screen 48 of the display panel 14 when the image signal is displayed thereon. A number of sensors 50 are employed and attached to the display panel 14 under the sensor locations 46. The sensors 50 are configured to identify which sensor location 46 is contacted and coupled to the MCU 32 to provide response to the contact. As shown, in this embodiment, the image signal can be adjusted among colors A˜J (in RGB space) and brightness levels 0˜9 (in YUV space). It should be noted that the CAC 44 is not limited by this embodiment but can be designed depending on need.

One method of color adjustment can be performed before a JPEG file of the image signal is created, according to the following steps 102-114.

In Step 102 a number of image frames of an image signal are captured that include a current image frame by the image sensor 20 and the lens unit 18.

In Step 104, the current image frame is encoded as a first preview image. Encoder 12 encodes the image frames of the image signal as a video signal shown on the display panel 14 so that the user may judge what, if any, color adjustment is desired, with parameters adjusted via the CAC 44.

In Step 106, the first preview image is displayed on the display panel.

In Step 108, the color of the current image frame is adjusted after the first preview image is displayed. Color adjustment unit 16 receives a current image frame and the color adjustment parameters and adjusts the color of the current image frame based thereon.

In Step 110, the adjusted current image frame is encoded as a second preview image by the encoder 12.

In Step 112, the second preview image is displayed to allow determination of the need for further color adjustment by the display panel 14.

In Step 114, the adjusted current image frame is stored if deemed complete, by depression of shutter key 42, at which time the adjusted image frame is sent to the JPEG CODEC 26, which compresses the adjusted image frame as a JPEG file, which is then sequentially stored in the memory unit 30.

If the adjusted current image frame is not deemed complete, the process returns to step 108 for more color adjustment until completion is achieved.

Additionally, the DSC 10 can further adjust the color of an existing JPEG file, by the following steps.

In Step 202, an image signal stored in the image capture device is selected, using display panel 14 to browse stored images.

In Step 204, the selected image signal is encoded as a first preview image.

In Step 206, the first preview image is displayed to allow determination of the need for color adjustment. The encoder 12 encodes the chosen JPEG file as a first preview image that shown on the display panel 14.

In Step 208, if deemed necessary, the color of the selected image is adjusted after the first preview image is displayed, setting color adjustment parameters via the CAC 44 based on the first preview image. The color adjustment unit 16 receives the JPEG file and the color adjustment parameters and adjusts the color of the JPEG file accordingly.

In Step 210, the adjusted image signal is encoded as a second preview image.

In Step 212, the second preview image is displayed to allow determination of whether further color adjustment is needed or if the adjusted image is acceptable; and

In Step 214, if deemed acceptable, the adjusted JPEG file is stored, replacing the original JPEG file. If not, more color adjustment can be performed until acceptability is achieved.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. An image capture device comprising:
an encoder configured encoding an image signal into a first preview image;
a display panel configured displaying the first preview image to allow determination of the need for color adjustment; and
a color adjustment unit configured adjusting the color of the image signal in response to input based upon the determination, wherein the adjusted image signal is encoded as a second preview image displayed by the display panel to allow determination of the need for further color adjustment.

2. The image capture device as claimed in claim 1, wherein the encoder is a video encoder.

3. The image capture device as claimed in claim 1, wherein the display panel is a liquid crystal display panel.

4. The image capture device as claimed in claim 1, wherein the image signal comprises a plurality of pixels each having a number of color values in a specific color space of RGB or YUV, where Y is a luminance component of the image signal, U and V are two chrominance components of the image signal, wherein the color adjustment unit adjusts the color of the image signal by changing the color values.

5. The image capture device as claimed in claim 1, further comprising a lens unit, an image sensor, a time generator, and a micro-control unit, the lens unit configured to expose the image sensor to an optical image, the image sensor configured to convert the optical image incident thereon into an image signal, the time generator configured to repeat mage signal output at a predetermined rate as a number of consecutive image frames, and the micro-control unit configured to control and coordinate the lens unit, the image sensor, and the time generator.

6. The image capture device as claimed in claim 5, wherein the image signal comprises a plurality of pixels, and the image capture device further comprises a digital signal processor processing the image signal to obtain a plurality of color values for each pixel in a specific color space.

7. The image capture device as claimed in claim 5, further comprising a JPEG CODEC and an input unit, the input unit comprising a shutter key, the shutter key configured to instruct the JPEG CODEC to compress a current image frame as a JPEG file.

8. The image capture device as claimed in claim 7, wherein the input unit comprises a color adjustment control configured to receive a color adjustment parameter, and adjusting the color of the image accordingly.

9. The image capture device as claimed in claim 8, wherein the color adjustment parameter is color or amount of adjustment.

10. The image capture device as claimed in claim 8, wherein the color adjustment control comprises a touch screen.

11. The image capture device as claimed in claim 1, further comprising a memory unit configured to store the image signal.

12. The image capture device as claimed in claim 1 being a digital still camera.

13. A color adjustment method for an image capture device comprising:
capturing a plurality of image frames of an image signal that comprises a current image frame;
encoding the current image frame as a first preview image;
displaying the first preview image to allow determination of the need for color adjustment;
adjusting the color of the current image frame based upon the determination;
encoding the adjusted current image frame as a second preview image;
displaying the second preview image to allow determination of the need for further color adjustment; and
storing the adjusted current image frame if the adjusted current image frame is deemed acceptable.

14. A color adjustment method for the image capture device as claimed in claim 13, further comprising returning to the color adjustment if the adjusted current image frame is not deemed acceptable.

15. A color adjustment method for an image capture device comprising:
selecting an image signal stored in the image capture device;
encoding the read image signal as a first preview image;
displaying the first preview image to allow determination of the need for color adjustment;
adjusting the color of the read image signal based upon the determination;
encoding the adjusted read image signal as a second preview image;
displaying the second preview image to allow determination of the need for further color adjustment; and
storing the adjusted read image signal if the adjusted read image signal is deemed acceptable.

16. A color adjustment method for an image capture device as claimed in claim 15, further comprising returning to the adjustment if the adjusted current image frame is not deemed acceptable.
